(19) United States
(12) Patent Application Publication
(10) Pub. No.: US 2012/0190383 A1
(43) Pub. Date: Jul. 26, 2012

(54) LOCATION MEASUREMENT METHOD

(75) Inventors: Kanghee Kim, Daejeon (KR); Geon Min Yeo, Daejeon (KR)

(73) Assignee: Electronics and Telecommunications Research Institute, Daejeon (KR)

(21) Appl. No.: 13/499,078

(22) PCT Filed: Sep. 29, 2010
(86) PCT No.: PCT/KR2010/006637

§ 371 Date: Mar. 29, 2012

(30) Foreign Application Priority Data
Sep. 30, 2009 (KR) 10-2009-0093232
Sep. 13, 2010 (KR) 10-2010-0089627

(51) Int. Cl. H04W 64/00

(52) U.S. Cl. 455/456.1

(57) ABSTRACT

In a method for a terminal to measure a location by using a public safety monitoring system, when a public safety mode available for tracking a location while a terminal is turned off is set, the terminal acquires location measurement information and transmits it to the public safety monitoring system. In a method for measuring a location of a terminal to which plural stages of public safety modes are set, when a stage for performing a location measurement process is set, the terminal acquires location measurement information, transmits location measurement information to the public safety monitoring system, and enters the next stage when the public safety mode is not cancelled after a predetermined time. In a method for measuring a location of a terminal in a public safety monitoring system, a public safety mode setting request message including control information is transmitted to the terminal to which a public safety mode setting is requested, location measurement information is received from the terminal, and the location of the terminal is tracked.

### BACKGROUND OF THE INVENTION

(a) Field of the Invention

The present invention relates to a location measurement method, and particularly relates to a method for measuring a location of a terminal to which a public safety mode is set.

(b) Description of the Related Art

A location based service (LBS) includes services that provide various information on locations, including a location tracking service and a public safety service. The location can be measured by a mobile communication base station using method and a GPS method. The base station using method may generate great errors but can measure indoor location by using a repeater, and the GPS method has a difficulty in measuring an indoor location even though it provides high accuracy.

The location tracking service checks or tracks the location of people or things, and particularly provides a location tracking service for the safety of a terminal owner. However, when the terminal is turned off, location information cannot be acquired and the terminal cannot be controlled even if the location of the terminal owner is tracked for the purpose of safety.

### SUMMARY OF THE INVENTION

The present invention has been made in an effort to provide a method for measuring a location of a terminal to which a public safety mode is set.

An exemplary embodiment of the present invention provides a method for a terminal to measure a location by using a public safety monitoring system, including: acquiring location measurement information of the terminal when a public safety mode available for tracking the location while the power is turned off is set; and transmitting the location measurement information to the public safety monitoring system.

The method further includes receiving a public safety mode setting request message including information for controlling the terminal from the public safety monitoring system, and the terminal is set with the public safety mode in response to the public safety predetermined request message.

The method further includes transmitting a setting finish message of the public safety mode to the public safety monitoring system when the public safety mode is set.

The acquiring of location measurement information includes acquiring information for location measurement in cooperation with at least one reference node and calculating a location of the terminal by using the information for location measurement, and the location measurement information includes information on the calculated location.

The acquiring of location measurement information includes acquiring information for location measurement in cooperation with at least one reference node, and the location measurement information includes information for the location measurement.

The transmitting includes transmitting the location measurement information according to a transmission period that is set to the public safety mode.

The method further includes changing the transmission period according to residual battery power information of the terminal.

The method further includes increasing a sleep cycle of the terminal when the public safety mode is set.

The method further includes changing to inner power of the terminal when the battery is eliminated from the terminal or the battery has no residual power in the public safety mode.

Another embodiment of the present invention provides a method for a terminal to which a plurality stages of public safety modes are set to measure a location, including: acquiring location measurement information of the terminal when a first stage for performing a location measurement process from among the plurality stages of public safety mode is set; transmitting the location measurement information to a public safety monitoring system; and entering a second stage next to the first stage when the public safety mode is not cancelled after a predetermined time.

The method further includes entering the most dangerous stage from among the stages when the terminal is turned off in the public safety mode.

The acquiring of location measurement information includes acquiring information for location measurement in cooperation with at least one reference node and calculating the location of the terminal by using the information for location measurement, and the location measurement information includes information on the calculated location.

Yet another embodiment of the present invention provides a method for measuring a location of a terminal in a public safety monitoring system, including: transmitting a public safety mode setting request message including information for controlling a terminal to the terminal from which a public safety mode setting is requested; receiving location measurement information of the terminal from the terminal; and tracking the location of the terminal by using the received location measurement information.

The tracking includes calculating the location of the terminal by using the location measurement information.

The method further includes retransmitting the public safety mode predetermined request message when failing to receive the location measurement information from the terminal.

The method further includes notifying a communication system that a public safety mode setting is requested to the terminal, and receiving a registration state of the terminal from the communication system.

According to an embodiment of the present invention, the location of the terminal can be tracked when it is turned off.

### BRIEF DESCRIPTION OF THE DRAWINGS

FIG. 1 shows a location measurement method according to an exemplary embodiment of the present invention.

FIG. 2 shows a flowchart of a location measurement method of a terminal according to an exemplary embodiment of the present invention.

FIG. 3 shows a flowchart of a location measurement method of a terminal according to another exemplary embodiment of the present invention.

FIG. 4 shows a flowchart of a location measurement method of a terminal to which a public safety mode with a plurality of stages is set according to an exemplary embodiment of the present invention.

FIG. 5 shows an operational method of a public safety monitoring system according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

In the specification, a terminal may indicate a mobile station (MS), a mobile terminal (MT), a subscriber station (SS), a portable subscriber station (PSS), user equipment (UE), and an access terminal (AT), and it may include entire or partial functions of the mobile station (MS), the mobile terminal, the subscriber station, the portable subscriber station, the user equipment, and the access terminal.

In the specification, a base station (BS) may indicate an access point (AP), a radio access station (RAS), a nodeB (Node-B), an evolved Node-B (eNB), a base transceiver station (BTS), and a mobile multihop relay (MMR)-BS, and it may include entire or partial functions of the access point, the radio access station, the nodeB, the evolved Node-B, the base transceiver station, and the mobile multihop relay-BS.

A method for measuring a location of a terminal to which a public safety mode is set according to an exemplary embodiment of the present invention will now be described with reference to accompanying drawings.

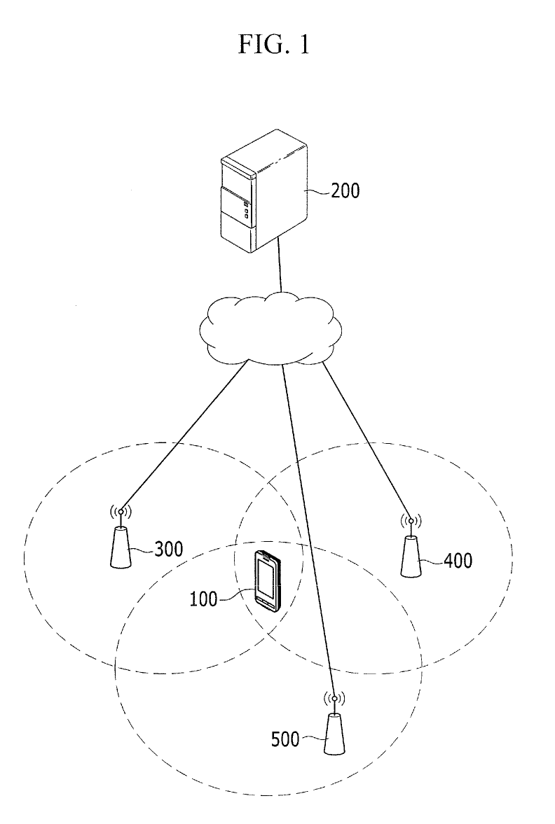

FIG. 1 shows a location measurement method according to an exemplary embodiment of the present invention.

Referring to FIG. 1, a location of the terminal 100 to which the public safety mode is set is measured through a public safety monitoring system 200 and a plurality of reference nodes (300-500). The reference nodes (300-500) include network devices for transmitting location measurement signals including a base station, a repeater, and a satellite station.

The public safety mode that enables tracking the location of the terminal when it is turned off can be set to the terminal 100. The terminal 100 to which the public safety mode is set transmits location measurement information to the public safety monitoring system 200. The location measurement information may be the location of the terminal 100 or the information for location measurement of the terminal 100.

The public safety monitoring system 200 monitors the terminal to which the public safety mode is set, and in detail, it sets the public safety mode to the terminal 100, tracks the location of the terminal 100 by receiving location measurement information from the terminal 100 to which the public safety mode is established, and controls the terminal 100.

The terminal 100 acquires information for measuring the location in cooperation with the reference nodes (300-500). The terminal 100 calculates the location by using the information for location measurement, or transmits the information for location measurement to another system, for example, the public safety monitoring system 200 that calculates the location of the terminal 100.

The location of the terminal 100 can be calculated by using the distance from the reference nodes (300-500). When a plurality of circles that have the reference nodes (300-500) as centers and the distances between the reference nodes (300-500) and the terminal 100 as radii are illustrated, the location where the circles are overlapped is determined as the location of the terminal 100. The location at which the circles are overlapped can be found by using an algorithm such as the least squares method based on triangulation when the distances between the terminal 100 and the respective reference nodes (300-500) are known.

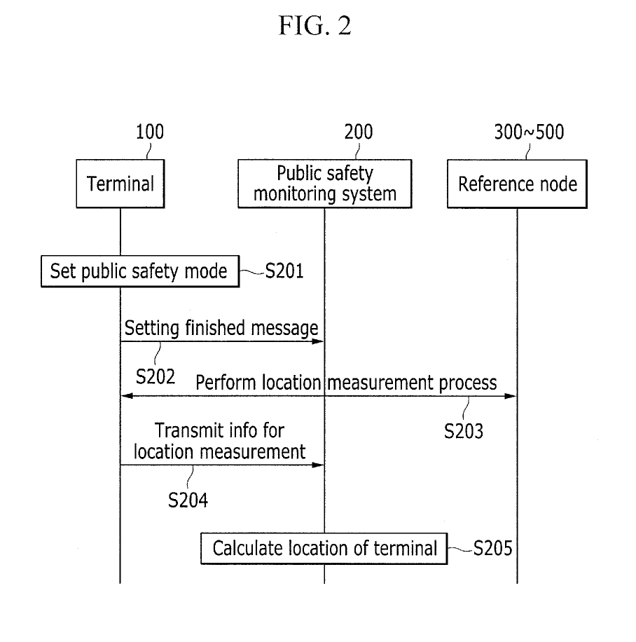

FIG. 2 shows a flowchart of a location measurement method of a terminal according to an exemplary embodiment of the present invention.

Referring to FIG. 2, the public safety mode that enables tracking the location of the terminal when it is turned off is set to the terminal (100 of FIG. 1) (S201). The public safety mode is set by a public safety mode setting request message provided by the public safety monitoring system 200 or the user. The public safety mode setting request message includes information for controlling the terminal operable in the public safety mode. When the public safety mode is set and the terminal 100 is turned off, the terminal 100 can change some of the settings of the terminal 100 so as to transmit information for tracking the location to the public safety monitoring system 200. Particularly, the terminal 100 can use an inner power supply of the terminal 100 when a battery of the terminal 100 is removed or the battery has no residual power in the public safety mode.

The terminal 100 transmits a message for reporting that the public safety mode is set, for example, a setting finished message, to the public safety monitoring system (200 of FIG. 1) (S202), and performs a location measurement process with the reference nodes (300-500 of FIG. 1) to acquire information for measuring the location (S203) by using at least one measurement method.

The terminal 100 transmits the information for location measurement to the public safety monitoring system 200 (S204). The terminal 100 transmits the information for measuring the location according to a transmission period that is set in the public safety mode. Also, the terminal 100 can increase a sleep cycle when the public safety mode is set in the sleep mode. In this instance, the terminal 100 can change the transmission period and the sleep cycle according to the state of the terminal 100, for example, residual battery power information, or it can change the same by receiving control information from the public safety monitoring system 200.

The public safety monitoring system 200 uses the received information to calculate the location of the terminal 100 and tracks the location (S205).

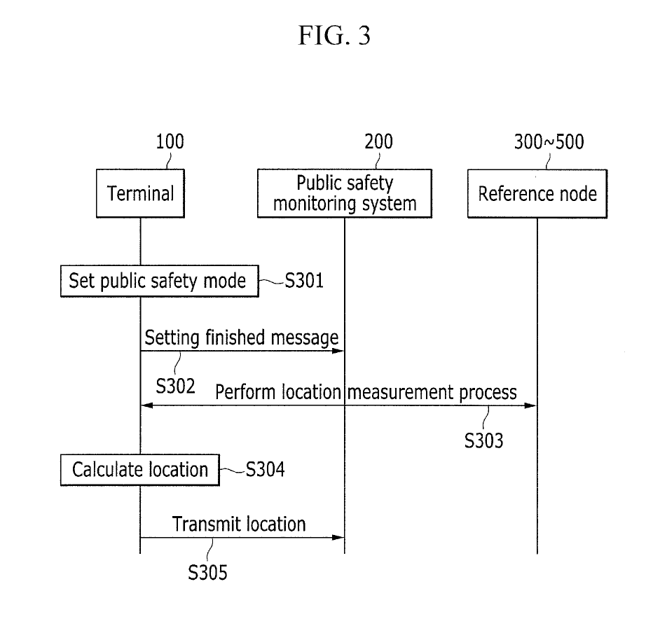

FIG. 3 shows a flowchart of a location measurement method of a terminal according to another exemplary embodiment of the present invention.

Referring to FIG. 3, when the public safety mode is set to the terminal 100 (S301), the terminal (100 of FIG. 1) transmits a message for reporting that the public safety mode is set to the public safety monitoring system (200 of FIG. 1) (S302).

The terminal 100 performs a location measurement with the reference nodes (300-500 of FIG. 1) (S303), and when the terminal 100 can directly calculate the location of the terminal 100, the terminal 100 calculates the location by using the information for location measurement (S304). When the terminal 100 can calculate the location, the terminal 100 can determine according to the battery residual power amount whether to directly calculate the location or to transmit information in order for the public safety monitoring system (200 of FIG. 1) or the reference nodes (300-500) to calculate the location. The public safety monitoring system 200 calculates the location according to the process shown in FIG. 2, and the reference nodes (300-500) transmits location information calculated by the reference nodes (300-500) to the public safety monitoring system 200.

The terminal 100 calculates the location of the terminal 100 and transmits it to the public safety monitoring system 200 (S305).

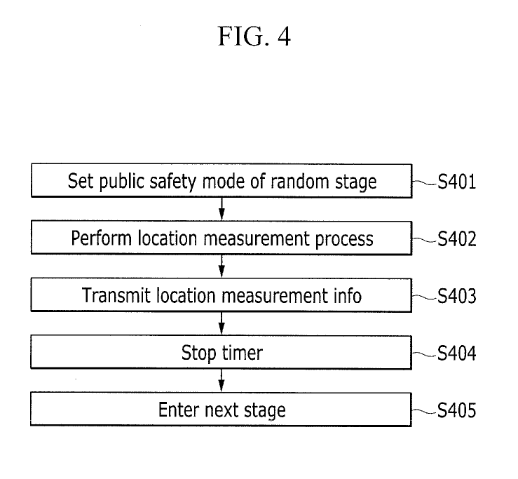

FIG. 4 shows a flowchart of a location measurement method of a terminal to which a public safety mode with a plurality of stages is set according to an exemplary embodiment of the present invention.

Referring to FIG. 4, a random stage from among a plurality of public safety modes is set to the terminal (100 of FIG. 1) (S401). The public safety modes can be differently set depending on the security requirement degree.

When the terminal 100 is set or enters the stage to perform the location measurement process from among the public safety modes, the terminal 100 acquires location measurement information in cooperation with the reference nodes (300-500 of FIG. 1) (S402).

The terminal 100 transmits the acquired location measurement information to the public safety monitoring system (200 of FIG. 1) (S403).

When a random stage of the public safety mode is set, the terminal 100 operates a timer, and enters the next stage (S405) when the timer is finished (S404). The timer can set a predetermined time for each stage, and when the public safety mode is not cancelled after the time set per stage is expired, the terminal enters the next stage to reach the most dangerous stage. When having been set with the most dangerous stage or having entered the same, the terminal 100 maintains the most dangerous stage until the public safety mode is cancelled.

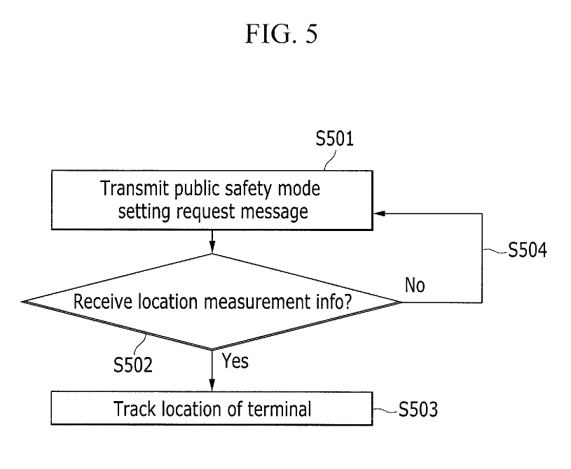

FIG. 5 shows an operational method of a public safety monitoring system according to an exemplary embodiment of the present invention.

Referring to FIG. 5, the public safety monitoring system (200 of FIG. 1) transmits a public safety mode predetermined request message to the terminal (100 of FIG. 1) to which a public safety mode setting is requested (S501).

The public safety monitoring system 200 receives location measurement information from the terminal 100 (S502) to track the location of the terminal 100 (S503) and calculate the location thereof. The public safety monitoring system 200 controls the terminal 100 so that the terminal 100 may periodically transmit information for location measurement.

When not knowing whether the public safety mode is set to the terminal 100, for example, when receiving no location measurement information or a public safety mode setting finish message from the terminal 100, the public safety monitoring system 200 retransmits the public safety mode setting request message (S504). Having received no public safety mode setting request message because the terminal 100 is not connected to the communication system, the terminal 100 can retransmit it when registered to a communication system such as a base station. For this, the public safety monitoring system 200 notifies the communication system thereof that the public safety mode setting is requested to the terminal 100, and receives a registration state of the terminal 100 and retransmits the same.

As described, the location-based service for the public purpose can be provided by monitoring the terminal to which the public safety mode is set and tracking the location by the public safety monitoring system.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for a terminal to measure a location by using a public safety monitoring system, comprising:
acquiring location measurement information of the terminal when a public safety mode available for tracking the location while the power is turned off is set; and
transmitting the location measurement information to the public safety monitoring system.

2. The method of claim 1, wherein the method further includes
receiving a public safety mode setting request message including information for controlling the terminal from the public safety monitoring system, and
the terminal is set with the public safety mode in response to the public safety predetermined request message.

3. The method of claim 1, further including
transmitting a setting finish message of the public safety mode to the public safety monitoring system when the public safety mode is set.

4. The method of claim 1, wherein
the acquiring of location measurement information includes:
acquiring information for location measurement in cooperation with at least one reference node; and
calculating a location of the terminal by using the information for location measurement,
wherein the location measurement information includes information on the calculated location.

5. The method of claim 1, wherein
the acquiring of location measurement information includes acquiring information for location measurement in cooperation with at least one reference node, and
the location measurement information includes information for the location measurement.

6. The method of claim 1, wherein
the transmitting includes
transmitting the location measurement information according to a transmission period that is set to the public safety mode.

7. The method of claim 6, further including
changing the transmission period according to residual battery power information of the terminal.

8. The method of claim 1, further including
increasing a sleep cycle of the terminal when the public safety mode is set.

9. The method of claim 1, further including
changing to inner power of the terminal when the battery is eliminated from the terminal or the battery has no residual power in the public safety mode.

10. A method for a terminal to which a plurality stages of public safety modes are set to measure a location, comprising:
acquiring location measurement information of the terminal when a first stage for performing a location measurement process from among the plurality stages of public safety mode is set;
transmitting the location measurement information to a public safety monitoring system; and
entering a second stage next to the first stage when the public safety mode is not cancelled after a predetermined time.

11. The method of claim 10, further including
entering the most dangerous stage from among the stages when the terminal is turned off in the public safety mode.

12. The method of claim 10, wherein
the acquiring of location measurement information includes:
acquiring information for location measurement in cooperation with at least one reference node; and
calculating the location of the terminal by using the information for location measurement,
wherein the location measurement information includes information on the calculated location.

13. A method for measuring a location of a terminal in a public safety monitoring system, comprising:
transmitting a public safety mode setting request message including information for controlling a terminal to the terminal from which a public safety mode setting is requested;
receiving location measurement information of the terminal from the terminal; and
tracking the location of the terminal by using the received location measurement information.

14. The method of claim 13, wherein
the tracking includes calculating the location of the terminal by using the location measurement information.

15. The method of claim 13, further including
retransmitting the public safety mode predetermined request message when failing to receive the location measurement information from the terminal.

16. The method of claim 15, further including:
notifying a communication system that a public safety mode setting is requested to the terminal; and
receiving a registration state of the terminal from the communication system.
